(19) United States
(12) Patent Application Publication
(10) Pub. No.: US 2008/0213080 A1
(43) Pub. Date: Sep. 4, 2008

(54) Compact Storage System and Its Application

(76) Inventors: Christian Cachelin, Zaziwil (CH); Bernhard Iseli, Fraschels (CH); Dietmar Reisch, Thun (CH); Jurg Steck, Kirchberg (CH); Thomas Stucki, Konolfingen (CH); Andre Wasserfallen, Uetendorf (CH); Lorenz Zellweger, Thun (CH)

Correspondence Address: NOTARO AND MICHALOS, 100 DUTCH HILL ROAD, SUITE 110, ORANGEBURG, NY, 10962-2100, US

(21) Appl. No.: 11/952,517

(22) Filed: Dec. 7, 2007

(30) Foreign Application Priority Data
Dec. 7, 2006 (CH) 01993/06

(51) Int. Cl. B65G 57/22

(52) U.S. Cl. 414/791.6; 414/806

(57) ABSTRACT

The invention relates to a compact storage system and a corresponding method for storing frozen specimens. The compact storage system comprises one storage area, a housing with thermal insulation and at least one refrigeration unit, with which at least the storage area is coolable down to a temperature of at least −15° C. The compact storage system also comprises storage shelves arranged completely within the refrigerated storage area and a transfer area arranged above this storage area. An essentially horizontally moving robot is arranged within the transfer area. The compact storage system is characterised in that it comprises at least one essentially vertical paternoster device, with a plurality of essentially horizontally oriented storage shelves circulating on an essentially oval path. The robot working in conjunction with the paternoster device is accomplished for removing or depositing a storage shelf and/or objects from/onto a storage shelf respectively. The robot is capable of this removing or depositing, when at least one storage shelf is located in the area of the upper semicircle of the path of this paternoster device. These objects for removing or depositing are selected from a group comprising the transfer frame, container racks and containers.

### RELATED PATENT APPLICATIONS

This patent application claims priority of the Swiss patent application No. 01993/06 filed on Dec. 7, 2006, the entire content of which is incorporated herein by explicit reference for all intents and purposes. The parallel European patent application No. EP 07 121 848.1 claims the same priority and has been filed on Nov. 29, 2007.

### RELATED FIELD OF TECHNOLOGY

The present invention relates to a compact storage system with one storage area, a housing comprising thermal insulation and at least one refrigeration unit, with which at least the storage area can be cooled to a temperature below −15° C. The compact storage system comprises storage shelves arranged completely within the refrigerated storage area and a transfer area arranged above this storage area, in which an essentially horizontally moving robot is arranged. Moreover, the present intervention relates to a method for storing frozen specimens in a corresponding compact storage system.

### RELATED PRIOR ART

Biological specimens, such as bodily fluids (for instance blood, urine, saliva, or sperm), cells (for instance bacterial cultures) or tissue samples are very sensitive to temperature and must be stored under refrigeration to prevent them deteriorating after they have been obtained. Consequently, an essential aspect of examining biological and generally temperature-sensitive specimens is the storage and availability of these specimens in a frozen state, i.e. at low temperatures. This can occur for instance in deep freezers (i.e. at temperatures no higher than −18° C.), in a gaseous atmosphere (i.e. at −78.5° C.) cooled by means of dry ice (solid CO₂) or in liquid nitrogen (at −196° C.). Moreover, systems for mechanical refrigeration by means of compressors are known, which are capable of achieving minimum temperatures of −35° C. (single-stage design), −85° C. (two-stage design) or −135° C. (three stage design), depending on the design. All these types of storage have been known for a long time and have their specific advantages and disadvantages. Samples stored at −18° C. can already show signs of deterioration after only a short time due to the formation of ice crystals. This formation of ice crystals is reduced considerably at dry ice temperatures and is practically absent in liquid nitrogen. However, containers cooled with dry ice heat up quite quickly when all the CO₂ is sublimated and the storage of specimens in liquid nitrogen is complex and only possible with special protective measures for personnel. There are few known systems that are particularly suitable for storing and making available large numbers of specimens by means of robotised and automatic systems.

The U.S. Pat. No. 6,357,983 B1 discloses an automatic storage system. Two ring-shaped racks nested within each other and rotatable around a central axis with a plurality of horizontally disposed shelf positions arranged one above the other are located in an air-conditioned chamber, the temperature of which can be selected to range from −20° C. to plus 20° C. These shelf positions can be loaded by a robot moving vertically and outside the racks. This robot is equipped with a specially articulated gripper mechanism so that it can reach into the inner shelf positions by reaching through an outer shelf in each case. This system has the advantage that the robot and therefore the specimen is located in a cold atmosphere during the entire selection process and can be removed from the storage system through an air lock. However, this storage system appears to be limited with respect to the number of shelf racks, so that a relatively large volume must be cooled for a relatively small number of specimens and a rather complex robot must be employed.

Another storage system is disclosed in the U.S. Pat. No. 6,694,767 B2. A completely thermally insulated storage space disposed for temperatures of −85° C. to −80° C. is located below a controlled atmosphere work area in which a robot with a workstation is arranged. Storage racks with relatively small horizontal dimensions and many shelves arranged one above the other are suspended vertically in openings of the thermally insulated cover and are provided with a top plate for closing the thermally insulated zone of this storage space in the deployed state. A robot lifts such a storage rack so far out of the storage space that a gripper is able to remove a specimen container from a rack position. Even though there is a risk of a specimen warming up or even thawing when the frame is being removed from the storage space, a controlled CO₂ atmosphere prevents aqueous vapour from condensing on the cold surfaces of the specimen containers.

The time required to make a specimen container available in this known storage system appears to be too long, above all when a large number of specimens must be made available within a short period of time.

A further storage system for storing and providing frozen specimens is known from the patent application JP 2004 131 249. This document discloses a storage space with circulating racks, each of which comprises a plurality of shelves with relatively small surfaces. Two of these circulating racks or horizontal paternoster devices are arranged in a refrigerated chamber, which is separated from a robot chamber by means of a wall interrupted by two openings. One robot takes a specimen container from a specific rack location on the circulating rack positioned closest to the one opening and gives this container to a second robot or a transfer area on the side opposite the storage chamber. The container can be identified by means of a camera. The storage chamber of this system appears to be relatively compact, however the robot requires a large amount of space, in particular if two robots are to be employed for making the specimens available and/or relocating the specimens from one specimen container to another.

A storage system with a plurality of vertical paternoster shelves that are serviced by at least one robot arranged above these shelves is disclosed in the patent CH 688 821 A5. The robot removes one storage container from the top shelf in each case. The goods are stored in a very compact and well utilised storage space with an unspecified temperature. The robot's paths appear to be very long for making many containers available efficiently, especially because only one container and/or object can be transported at a time.

In addition, storage systems produced by Remp AG (Oberdiessbach, Switzerland) are known, in which specimens can be stored, for instance in the REMP Small-Size Store™ system at temperatures of +4° C. or −20° C. or in the REMP Bio-Sample Store™ system at −80° C. A robot is employed in the latter, working at −20° C.

### OBJECT AND SUMMARY OF THE PRESENT INVENTION

The object of the present invention was to propose an alternative storage system for frozen specimens that eradicated or at least minimised the known disadvantages in the prior art.

This object is fulfilled in accordance with a first aspect by means of a compact storage system comprising one storage area, a housing comprising thermal insulation and at least one refrigeration unit. This refrigeration unit can cool at least the storage area to a temperature that lies below −15° C. This compact storage system comprises storage shelves arranged completely within the refrigerated storage area and a transfer area arranged above this storage area, in which an essentially horizontally moving robot is arranged. The compact storage system in accordance with the invention is characterised in that it comprises at least one paternoster device which is arranged in the storage area and is essentially vertical, which paternoster device comprises a longitudinal axis and a plurality of essentially horizontally oriented storage shelves circulating in an essentially oval path of travel, with the robot working in conjunction with a paternoster device, the robot device being accomplished for the purpose of and being capable of removing or depositing a storage shelf and/or removing objects from and/or placing them on a storage shelf, when at least one storage shelf is located in the area of the upper semicircle of the circulatory path of this paternoster device, with these objects being selected from a group comprising the transfer frames, container racks and containers.

This object is fulfilled in accordance with a second aspect by means of a method for storing and making available frozen specimens in such a compact storage system. The method in accordance with the invention is characterised in that the frozen specimens are stored in at least one at least essentially vertical paternoster device arranged in the storage area of the compact storage system with a longitudinal axis and a plurality of essentially horizontally oriented storage shelves circulating on an essentially oval path or are made available from it, with the robot working in conjunction with a paternoster device for the purpose of and being capable of removing or depositing a storage shelf and/or removing objects from and/or placing them on a storage shelf, when at least one storage shelf is located in the area of the upper semicircle of the circulatory path of this paternoster device, with these objects being selected from a group comprising the transfer frames, container racks and containers.

Additional preferred and inventive characteristics in each case are derived form the specification and the attached claims.

In the context of the present invention the geometric term “oval” is defined as an intrinsically closed, essentially O-shaped line. In the case of such an oval, the two essentially straight sections of equal length extend practically parallel to each other. The two neighbouring ends of their straight sections are connected to each other in each case by an at least approximate semicircle.

### BRIEF INTRODUCTION OF THE DRAWINGS

The present invention will now be described in greater detail with reference to exemplary embodiments and schematic drawings which do not restrict the scope of the invention.

FIG. 1 shows a vertical longitudinal section through a compact storage system in accordance with a first embodiment;

FIG. 2 shows a plan view of the compact storage system in FIG. 1;

FIG. 3 shows a vertical longitudinal section through a compact storage system in accordance with a second embodiment;

FIG. 4 shows a schematic 3D-view of a storage or work magazine;

FIG. 5 shows a vertical cross-section through a transfer station, in which a puncher thrusts a specimen container from a compartment of a storage magazine into a compartment of a work magazine;

FIG. 6 shows 3D-views of paternoster devices with two main chain drives and with a frame, wherein:

FIG. 6A shows a first variant with a stabilising lateral chain drive, and

FIG. 6B shows a second variant with a stabilising cam disc;

FIG. 7 shows an enlarged 3D-view of FIG. 6A, in which the lateral and the axial offset of the main chain drive in relation to the lateral chain drive is clearly visible;

FIG. 8 shows a 3D-view of a robot with two gripper frames, two heads and a transfer station.

### DESCRIPTION OF THE PREFERRED EMBODIMENTS OF THE INVENTION

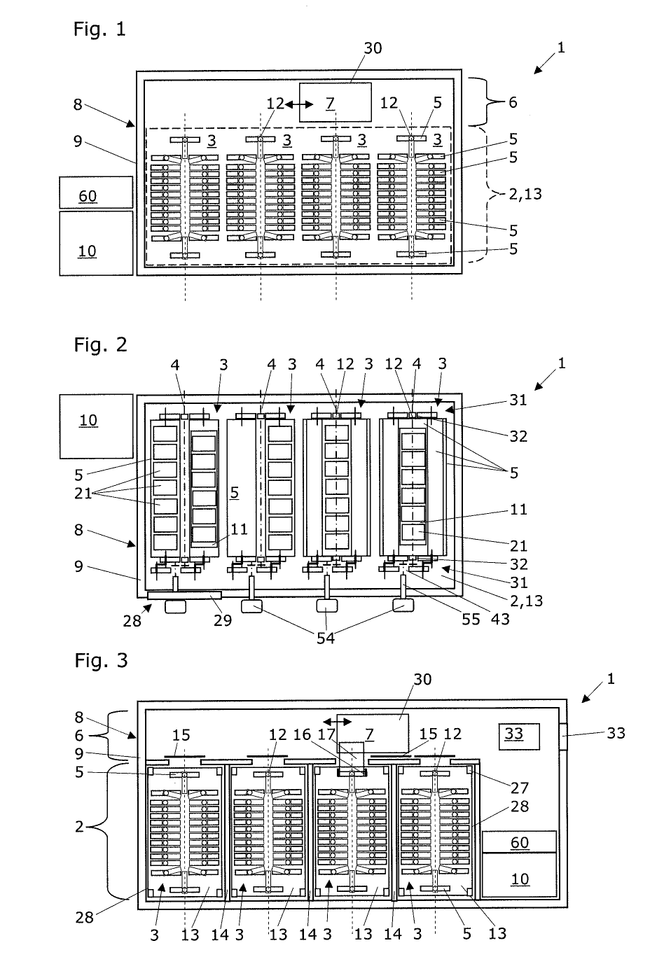

FIG. 1 shows a vertical longitudinal view or section through a compact storage system 1 in accordance with a first embodiment. This compact storage system 1 comprises a storage area 2, which is arranged in a housing 8 provided with thermal insulation 9. Furthermore, this compact storage system 1 comprises at least one refrigeration unit 10, with which at least the storage area 2 can be refrigerated to a temperature below −15° C. The refrigeration unit 10 can be arranged within the housing (cf. FIG. 3) or, as shown here, outside the housing 8. The compact storage system 1 comprises storage shelves 5 that are arranged completely within the refrigerated storage area 2, irrespective of their storage location. A transfer area 6 is arranged above this storage area 2 within the housing 8, in which an essentially horizontally displaceable robot 7 is housed (see double arrow in FIGS. 1 and 3).

The compact storage system 1 in accordance with the invention comprises at least one at least essentially vertical paternoster device 3 arranged in the storage area 2. This paternoster device comprises a longitudinal axis 4 and a plurality of essentially horizontally oriented storage shelves 5 circulating in an essentially oval path of travel. The robot 7 working in conjunction with such a paternoster device 3 is developed and accomplished for removing or depositing a storage shelf 5. It is also designed for removing objects from a storage shelf 5 or placing them on one. However, as a result of the interaction with the paternoster device 3, the robot 7 is only capable of performing these actions when at least one storage shelf 5 is positioned in the area of the upper circulatory semicircle of this paternoster device 3. These objects are selected from a group comprising the transfer frames 11, container racks 21 and containers 17.

The test tubes manufactured for instance from glass or plastic are referred to as “containers or specimen containers”. Test tubes also encompass “ylals” and “tubes”. In particular, vials and tubes are developed essentially cylindrically and are preferably stored or transported in magazines or racks. Highly preferable are container racks 21, which are provided with essentially the same footprint as a microplate. However, the term “container” also comprises all other vessels that are suitable for enclosing liquids, solids or mixtures of liquids and solids. For instance, small bottles with lids are such containers, where these small bottles can be manufactured from glass or plastic and the lid developed for example as a screw top lid, snap-on cap or plug. Also included here are containers with a foil or film as a means of closure.

In robotised laboratories microtube cluster racks are especially preferred because these have a footprint that corresponds to the footprint of a microplate in accordance with the SBS standard (SBS=Society for Biomolecular Screening), often referred to as the “SBS footprint”. This standard has been adopted as ANSI/SBS 1-2004 Standard by ANSI (American National Standards Institute). Racks with 96 microtubes are known. The aforementioned company Remp AG also supplies microtube cluster racks with 96 or 384 microtubes under the commercial name REMP Tube Technology™.

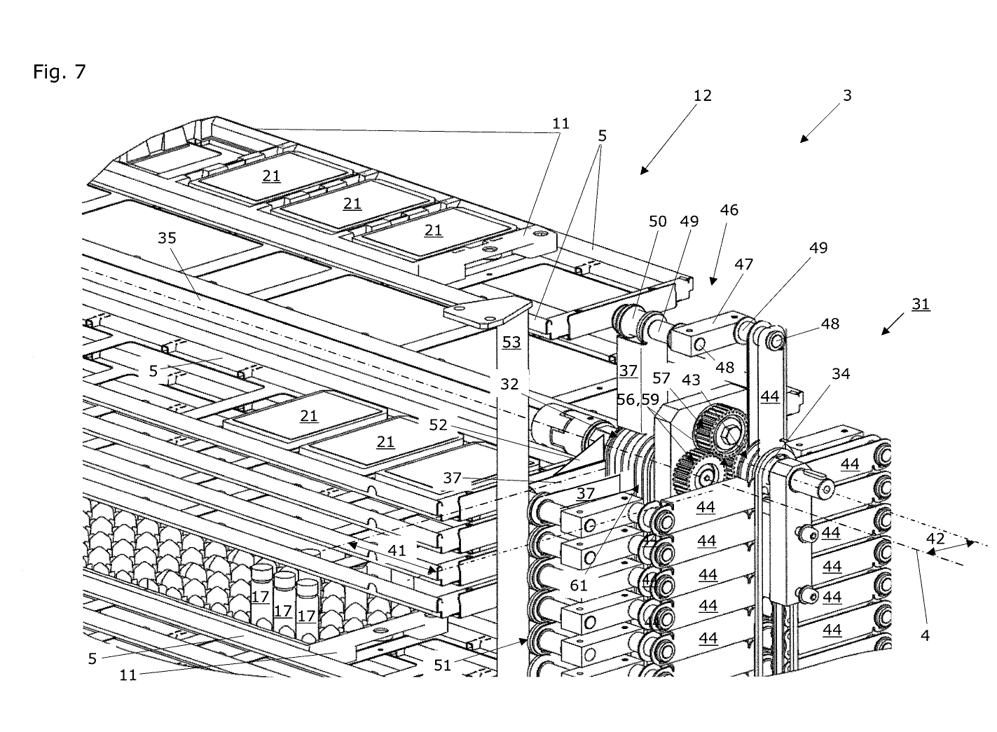

Such container racks 21 can be placed directly onto the storage shelves 5. Preferably, the storage shelves are provided with appropriate depressions and/or compartments (see FIG. 7) to prevent the container racks 21 slipping on the storage shelves 5, therefore unambiguously defining the position of a container rack on a storage shelf. Container racks positioned clearly in this manner can be addressed by the robot 7 and grasped precisely with confidence when at least one storage shelf 5 is positioned in the area of the upper circulatory semicircle of this paternoster device 3. Preferably, storage shelves are manufactured from sheet aluminium or sheet chromium steel. Aluminium in particular is a good thermal conductor and such aluminium shelves are relatively light, but sufficiently stable nevertheless.

However, such container racks 21 can also be placed onto a transfer frame 11, which is also provided with appropriate depressions and/or compartments (cf. FIG. 7) to prevent the container racks 21 sliding on the transfer frames 11 in order to unambiguously define the position of a container rack on a transfer frame. Preferably, these transfer frames 11 are slightly shorter than the storage shelves 5 and can be placed accurately on these in terms of their position (cf. FIG. 7). Preferably, the transfer frames 11 are manufactured from a plastic material. The transfer frames 11 can also comprise an array of pylons instead of the depressions and/or compartments for the container racks 21, between which test tubes or other containers 17 can be inserted (cf. FIG. 7). Container racks 21 can also comprise such pylons, so that vials and test tubes can be placed into and/or removed from these container racks 21 manually or by robotised means.

Provision can also be made for the robot 7 working in conjunction with a paternoster device 3 to be embodied for the purpose of and being capable of removing or depositing a storage shelf 5 and/or removing objects from and/or placing them onto a storage shelf, when this storage shelf 5 is located at least near the upper inflection point 12 of the paternoster device 3. The higher the position of the objects to be removed, the simpler these can be grasped by the gripper 20 of the robot 7. Alternatively, provision can be made for the robot 7 working in conjunction with a paternoster device 3 to be developed for the purpose of and being capable of removing or depositing a storage shelf 5 and/or removing objects from and/or placing them onto a storage shelf 5, when two storage shelves 5 are each positioned at a distance from the upper inflection point 12 of the paternoster device 3 that is essentially one quarter of the upper circulatory semicircle. This alternative form of presentation has the advantage that for each paternoster device two storage shelves can be simultaneously positioned to be accessible for the robot 7.

A single paternoster device 3 (not shown) can be arranged in a single storage chamber 13, but also two or more paternoster devices 3 (e.g. four, as shown in FIG. 1). When provision is made for at least two paternoster devices 3, the paternoster devices 3 are preferably arranged essentially parallel adjacent to each other, with the robot 7 then developed preferably such that it is displaceable perpendicular to the longitudinal axes 4 of these paternoster devices 3. This can be seen from a combination of the two FIGS. 1 and 2, with FIG. 2 showing a plan view of the compact storage system 1 shown in FIG. 1 in vertical cross-section according to the simpler first embodiment.

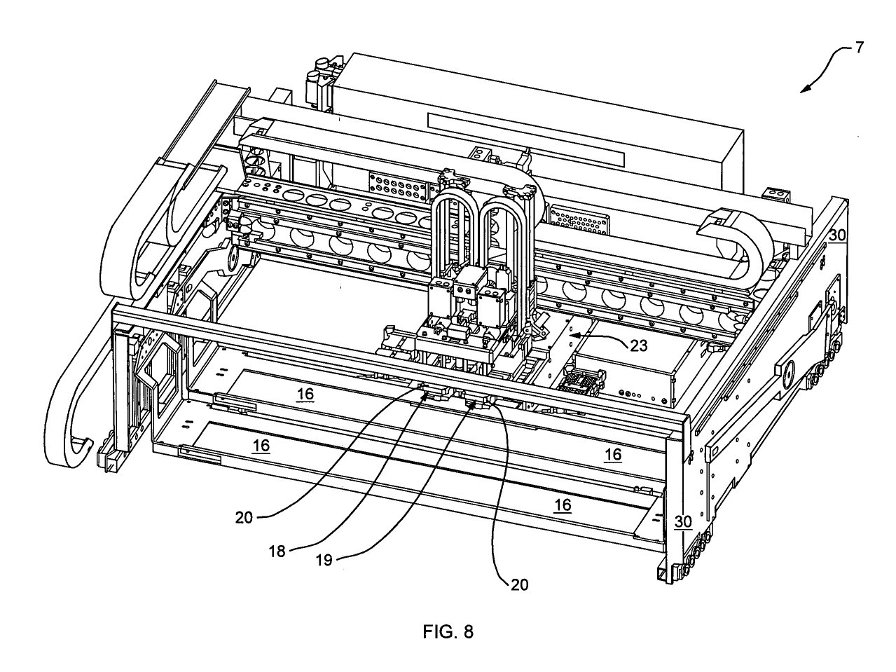

FIG. 3, which shows a vertical longitudinal view through a compact storage system in accordance with a second embodiment, shows a preferred refinement of the compact storage system 1 in accordance with the invention. The storage area 2 of this compact storage system 1 comprises storage chambers 13 that are permanently separated from each other by means of thermally insulated partitions 14. In this case, a paternoster device 3 is arranged in each storage chamber 13. Similarly, in this case paternoster devices 3 are preferably arranged essentially parallel adjacent to each other and the robot 7 are embodied such that it is displaceable perpendicular to the longitudinal axes 4 of these paternoster devices 3. The temperature in all these thermally separated storage chambers 13 can be the same or different, depending upon requirements. Preferably, the robot 7 comprises at least one gripper frame 16 to block a paternoster device 3 and to remove and/or deposit a transfer frame 11 from a storage shelf 5 or to remove and/or deposit a storage shelf 5 of the blocked paternoster device 3 (cf. also FIG. 8). In variance to this representation, provision can be made for similar insulated, but removable partitions (so-called “mobile partitions”, not shown) are only employed on both sides of a paternoster device 3 when special work is to be performed on this paternoster device 3, such as in break-down events or for service work and/or if this paternoster device 3 is to be a least temporarily removed from the storage area 2 of the compact storage system 1 or to be replaced by another paternoster device 3.

Highly preferable is for each storage chamber 13 to comprise at least one sealable loading hatch 15. This means that the storage chambers can be totally thermally insulated from each other. In this way, a single storage chamber 13 can for instance be thawed for maintenance work without compromising the functionality of the other storage chambers 13 or even the compact storage system 1.

Particularly with respect to the second embodiment, but also with respect to the first, preference is for the storage area 2 to be able to be refrigerated to a temperature of −35° C. or lower. In addition, the transfer area 6 should be able to be refrigerated to a temperature below −15° C. This temperature difference does not normally compromise the quality of the frozen specimens because these specimens are grasped in a closed container 17, with or without a container rack 21 and/or transfer frame 11. Gripping is carried out by a robotic gripper 20 that is pre-chilled to at least −15° C. The specimens can be transferred in a container rack 21, a transfer frame 11 or a storage shelf 5 held by a robot, the container rack, transfer frame or storage shelf being also pre-chilled to −15° C.

In a particularly preferred embodiment of the compact storage system 1, the storage area 2 can be cooled to a temperature of −80° C. In this case, preference is for the transfer area 6 to be cooled to a temperature of −20° C. These temperatures, as described initially, can be generated using a refrigeration unit 10, which for instance comprises a compressor, the first stage of which provides a temperature of −20° C. for the transfer area 6, and the first and second stage of which provides a temperature of −80° C. for the storage area 2.

The compact storage system 1 preferably comprises at least one lock 33. This lock is accomplished for the deposition and/or removal into/from the compact storage system 1 of storage shelves 5, transfer frames 11, storage magazines or container racks 21. These storage shelves, transfer frames, storage magazines or container racks preferably comprise specimen containers in the form of vials 17, tubes 22 or other containers, such as for example small glass jars with screw top lids, and work magazines 24.

Preferably, each paternoster device 3 is constructed in a rack 27 and can be removed laterally from the housing 8 of the compact storage system 1 together with this rack 27 through an opening 28. In order to prevent the development of any thermal bridges, this opening 28 is closed by means of a cover 29 equipped with thermal insulation 9 once the paternoster device 3 is inserted (cf. FIG. 2). This cover 29 can be fastened to the rack 27 so that it can be removed together with the paternoster device 3 from the compact storage system 1. However, the cover 29 can also be embodied as a door and be attached to the housing 8 of the compact storage system 1. Each paternoster device 3 preferably comprises one drive motor 54 arranged outside the storage area 2, which is connected to the lateral chain drive 43 through a thermally insulated rotary joint 55. However, if the temperature of the storage area 2 is −20° C., the drive motors 54 can also be arranged within the storage area 2.

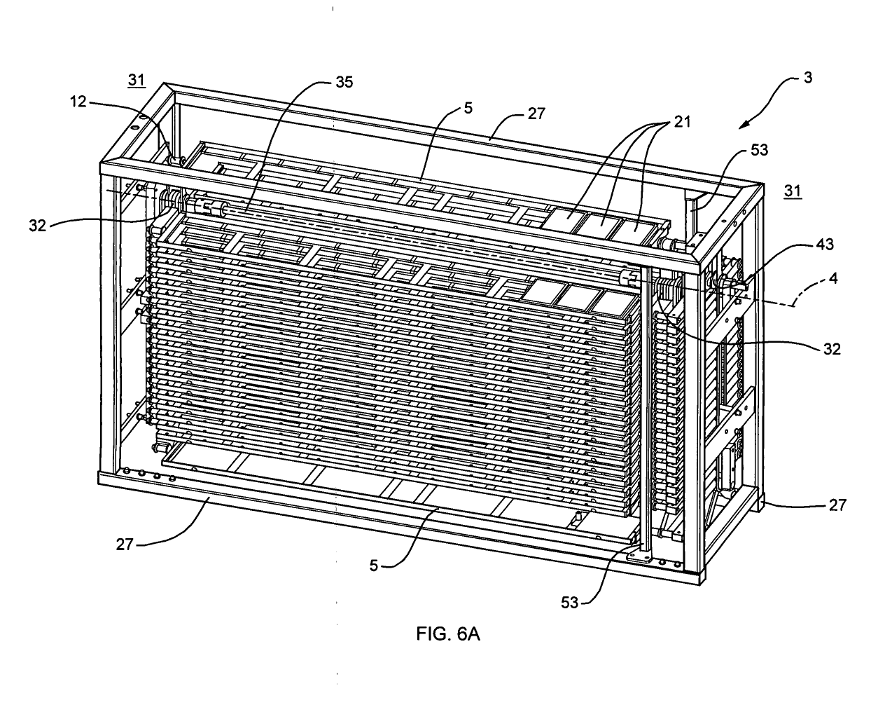

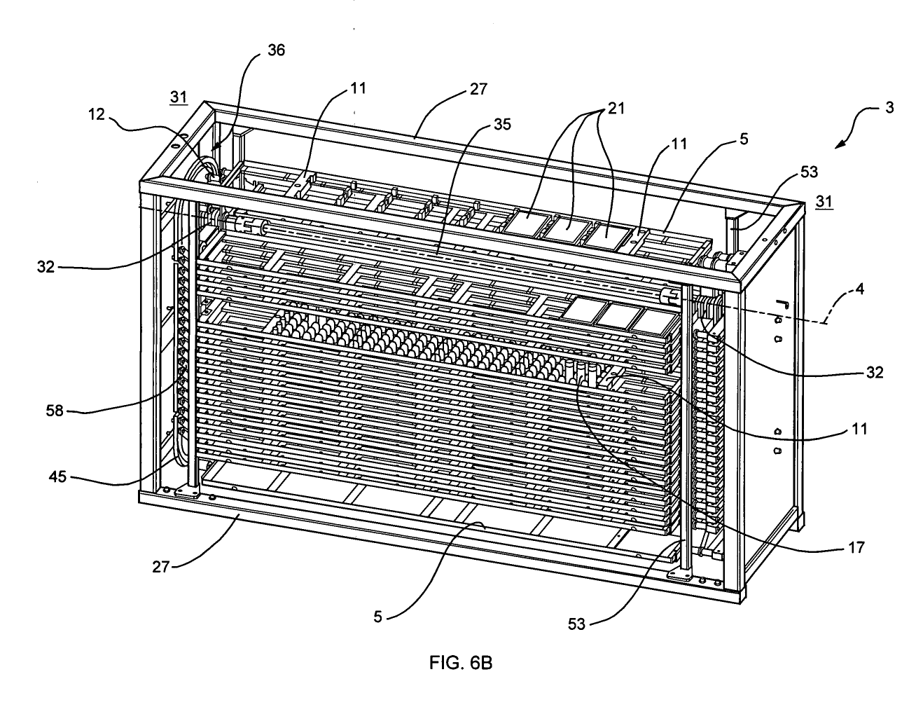

FIGS. 6A and 6B show 3-D views of paternoster devices 3 with two main chain drives 32 and with such a rack 27. Each paternoster device 3 comprises two essentially vertical main chain drives 32 with roller chains arranged at their two ends 31. These roller chains ran around upper and lower sprocket wheels 34. The main chain drives 32 are joined to each other mechanically by means of at least one shaft 35. Adjacent links of these roller chains are connected to each other by means of link plates developed as shelf bearers 37. Preferably, link pins are inserted through each shelf bearer 37. Preferably, each main chain drive 32 comprises two parallel roller chains, each link of which is encompassed by a preferably U-shaped shelf bearer 37. Other intrinsically non-load-bearing supporting chains 61 can be arranged parallel to these as additional stabilisers for the roller chains of the main chain drive 32 (cf. also FIG. 7). Preferably, each main chain drive 32 comprises an additional parallel supporting chain 61, the links of which are not encompassed by the shelf bearers 37.

FIG. 6A shows a first variant of such a paternoster device 3, characterised by a stabilising lateral chain drive 43. This lateral chain drive 43 prevents the storage shelves 5 from tilting and ensures that the storage shelves 5 maintain their at least approximate horizontal position along their whole path of travel in the paternoster device 3. The paternoster device 3 with the essentially horizontally held storage shelves 5 in accordance with the invention can be operated continuously forwards as well as backwards. Each paternoster device 3 in accordance with this first variant comprises an essentially vertical lateral chain drive 43 with roller chains arranged at its one end 31 (cf. also FIG. 7). These roller chains of the lateral chain drive 43 run around upper and lower sprocket wheels 34 and are offset from the main chain drive 32 by an axial offset dimension 41 and a lateral offset dimension 42. Adjacent chain links are connected to each other by means of link plates developed as dummy bearers 44. Preferably, each lateral chain drive 43 comprises one roller chain, the links of which are each encompassed by a U-shaped dummy bearer 44. Preferably, link pins are inserted through these shelf bearers 37 or these dummy bearers 44 accordingly. It is also preferable for each shelf bearer 37 to be connected to a dummy bearer 44 by means of an intrinsically stiff articulated connection 46 which bridges the axial offset dimension 41 and the lateral offset dimension 42. In this illustrated embodiment of the first variant of the paternoster device 5 [sic!] at least one toothed drive wheel 56 of the main chain drive 32 is functionally connected mechanically to one toothed drive wheel 59 of the lateral chain drive 43 by means of an intermediate toothed wheel 57 or a toothed belt (not shown in FIG. 7). Preferably, the connection 46 is developed as a Z-shaped element with an elongated part 47 and two transverse shanks 48, with the transverse shanks 48 developed as rotational axes mounted rotatably in sleeves 49 arranged on the shelf bearers 37 or on the dummy bearers 44 (cf. also FIG. 7).

Furthermore, provision can be made for the sleeves 49 arranged on the shelf bearers 37 to additionally comprise rollers 50 with two peripheral flanges 51. These flanges 51 define the exact distance between the storage shelves 5, with the outside diameter of these flanges preferably corresponding to exactly twice the dimension of the pitch of the chain. In this embodiment a chain pitch of 15.875 mm was selected, such that each outside diameter of the flanges 51 is 31.75 mm.

Preferably, a compact storage system 1 with such paternoster devices 5 is embodied for storing storage magazines and/or container racks 21 with the footprint and normal height of a standard microplate, or with the same footprint and an integral multiple of this normal height. Highly preferable is a compact storage system 1 that is provided with at least three paternoster devices 3 and a specific storage capacity of at least 100 standard microplates per cubic metre.

Each compact storage system 1 in accordance with the invention preferably comprises one master computer 60 to regulate the storage area and transfer area temperatures and to control the motors 54 of the paternoster drives and the robot 7. Preferably, the computer 60 is provided with software that enables this computer to perform temporally optimised scheduling of the work to be performed by the robot 7. With the aid of such scheduling methods, large numbers of specimens can be placed into or made available from these paternoster devices 5 within a very short period of time. Such work also includes reformatting tubes from third-party manufacturers provided to the robot loosely in magazines. It is very advantageous to have a robot 7 that is capable of gripping such individual tubes. Such tubes from third-party manufacturers can for instance be placed on a transfer frame 11 and placed on a storage shelf 5 with this transfer frame 11. The third-party manufacturer magazines and the racks for vials 17 can also be provided with a footprint that deviates from that of the SBS standard. Similarly, the robot 7 can comprise exchangeable grippers that fit containers and/or racks that do not comply with the SBS standard.

FIG. 6B shows a second variant of such a paternoster device 3 with a stabilising cam disc 36. Each of these paternoster devices 3 comprises one essentially vertical cam disc 36 arranged at one of their ends 31, with a cam rail 45 and cam bails 58. Each of the dimensionally stable cam bails 58 corresponds with a shelf bearer 37 carrying a storage shelf 5 and is pivotally connected to it. In combination with one oval cam rail 45 corresponding to the path of travel of the paternoster device and the cam bails 58, this cam disc 36 prevents the storage shelves 5 from tilting and ensures that the storage shelves 5 maintain their at least approximately horizontal position along their whole path of travel in the paternoster device 3. This paternoster device 3 in accordance with the invention with the essentially horizontally held storage shelves 5 can be operated running forwards as well as backwards.

FIG. 7 shows an enlarged 3-D view of FIG. 6A. The lateral offset of the one main chain drive 32 and the axial offset of this main chain drive with respect to the lateral chain drive 43 can be seen clearly here. In addition, it can also be seen clearly that the shelf bearers 37 can comprise moulded supports 52 that reliably support the shelf bearers 37 in an essentially horizontal position with respect to the main chain drive 32. Preferably, each paternoster device 3 comprises essentially vertically arranged guide rails 53 that engage between the rotary flanges 51 of the rollers 50 arranged on the shelf bearers 37. Furthermore, the third-party manufacturer's tubes and/or vials 17 are clearly visible, and the manner in which they are located on a transfer frame 11 between its pylons and located with this transfer frame 11 on a storage shelf 5.

FIG. 8 shows a 3-D view of a robot 7 with two gripper frames 16, two heads 18, 19 and a transfer station 23. The robot 7 comprises at least one, but preferably two heads 18,19. This one head 18 and/or these two heads 18, 19 is/are each equipped with one gripper 20 for grasping container racks 21 with specimen containers 17 or for tubes 22 and/or for grasping specimen containers 17 arranged in container racks 21 or transfer frames in 11. Preferably, the robot 7 also comprises a transfer station 23 for redistributing these specimen containers 17,22 in work magazines 24. Preferably, the robot 7 is equipped with one gripper 20, with which it can hold containers 17 of any kind, such as for instance entire container racks 21 with an SBS footprint, but also individual, preferably cylindrical specimen containers such as test tubes and vials. Preferably, the robot 7 comprises at least one gripper frame 16 to block a paternoster device 3 and to remove and/or deposit a transfer frame 11 from a storage shelf 5 or to remove and/or deposit a storage shelf 5 of the blocked paternoster device 3. In this way, the gripper frame 16 grasps preferably tray-shaped specimen carriers, such as storage shelves 5 and transfer frames 11.

The transfer station 23 comprises a puncher 25, with which tubes 22 can be pressed out of the compartments 26 of a container rack 21 into compartments 26 of a work magazine 24 arranged below the container rack 21. As mentioned previously, microtube cluster racks are particularly preferred in robotised laboratories, because these are provided with a footprint that corresponds to the footprint of an SBS standard microplate. The aforementioned company Remp AG also supplies microtube cluster racks with 96 or 384 microtubes under the commercial name REMP Tube Technology™. The essential difference between these and the remaining state-of-the-art racks and microtubes is that the specimen tubes are made available by arranging at least two racks one above the other and the test tubes are pressed by a manipulator out of the upper rack into the accommodating cavities of the rack below, positioned in register or accordance with the index. On the other hand, this transfer process can also be executed by means of a manipulator pressing the test tubes out of the lower rack into the appropriately positioned accommodating cavities of the upper rack (cf. e.g. EP 0 904 841 B1 or U.S. Pat. No. 6,827,907 B2).

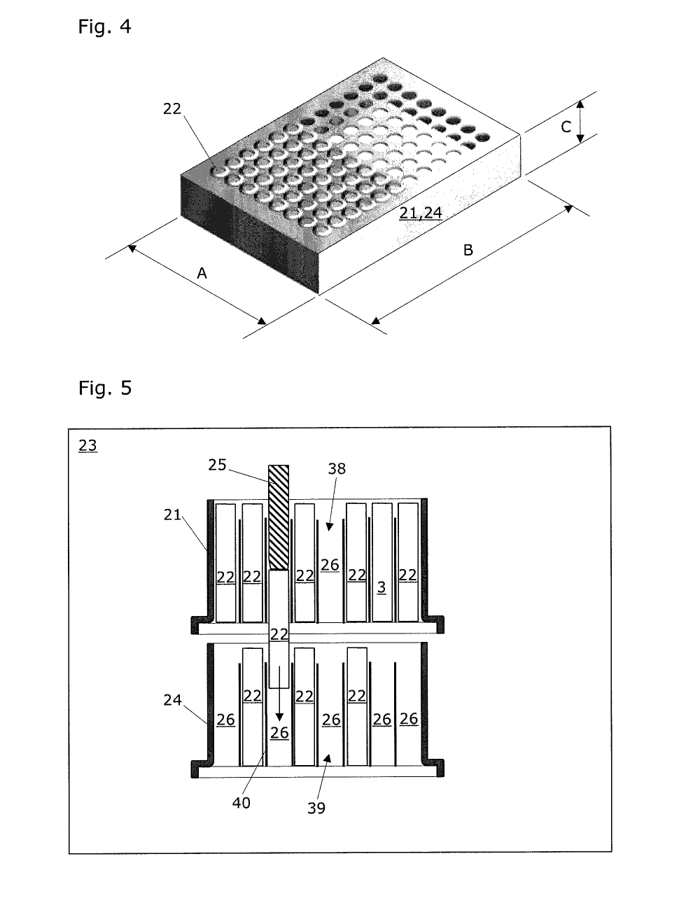

Reference is hereby made again to FIGS. 4 and 5 that show a schematic 3-D view of a storage magazine and/or container rack 21 or a work magazine 24 and/or a vertical profile through a transfer station 23.

In the transfer station 23 a puncher presses a specimen container from a compartment of a container rack 21 into a compartment of a work magazine 24. The container rack 21 and work magazine 24 are constructed essentially identically and differ from each other primarily in terms of their application. Container racks 21 are used for storing and making available containers 17 or tubes 22. On the other hand, work magazines 24 are used by the robot 7 or by an operator and are generally supplied to a processing or analysis procedure conducted outside the compact storage system 1. The container racks 21 are provided with partitions 40 that separate a plurality (preferably 96 or 384) of compartments 26 from each other. These compartments are provided with an upper opening 38 and a lower opening 39, so that containers (preferably in the form of sealed tubes 22) can be placed in any selected compartment from above or from below. This placement is preferably executed automatically by means of the tool or puncher 25. Preferably, the container racks 21 and/or work magazines 24 are provided with a width A and a length B that define an SBS footprint. Preferably, the height C of these racks or magazines also corresponds to a standard height of microplates. As an alternative to the shown container racks 21 for tubes 22, container racks can be developed that accommodate tissue cassettes and are also preferably provided with an SBS footprint (not shown). Preferably, such alternative container racks are provided with 24 compartments, each for accommodating one tissue cassette resting on its side, and are preferably provided with double the height of a standard microplate.

Preferably, the robot 7 is constructed in a structural frame 30 and is developed together with the gripper frame 16, the heads 18,19 and the transfer station 23 such that it can be removed from the compact storage system 1. This is especially preferred for servicing purposes, as this allows the whole robot to be removed from the compact storage system 1 without having to thaw the transfer area 6. Consequently, the storage area 2 also remains unaffected by robot 7 servicing, which is especially favourable when all the paternoster devices 3 are located in a common storage chamber 13.

Preferably, the compact storage system 1 in accordance with the invention is utilised to execute a corresponding method for storing frozen specimens and making them available. In a compact storage system 1 described above, this method involves the frozen specimens being stored in at least one at least essentially vertical paternoster device 3 with a longitudinal axis 4 that is arranged in the storage area 2 of the compact storage system 1 and a plurality of essentially horizontally oriented storage shelves 5 circulating along an essentially oval path. The robot 7 working in conjunction with a paternoster device 3 removes a storage shelf 5 or sets it down inside. The robot can also remove objects from a storage shelf 5 and/or place them on a storage shelf. The robot can only perform this work when at least one storage shelf 5 is positioned in the area of the upper circulatory semicircle of this paternoster device 3. These objects are selected from a group comprising transfer frames 11, container racks 21 and containers 17.

In particular, the robot 7 can perform this work, when this storage shelf 5 is positioned at least in the proximity of the upper inflection point 12. The direction from which the storage shelf 5 comes to be in this position is irrelevant. Alternatively, the robot 7 is developed for the purpose of and being capable of removing or depositing a storage shelf 5 and/or objects from/onto a storage shelf 5 respectively, when two storage shelves 5 are each positioned at a distance from the upper inflection point 12 that is essentially one quarter of the upper circulatory semicircle.

The method in accordance with the invention can be executed particularly efficiently and in a time-saving manner when each paternoster device 3 is provided with its own drive motor. In this manner, each paternoster device can be moved independently of the other paternoster devices 3. Highly preferable is for the drive motors 54 of all the paternoster devices 3 to be controlled by a master computer 60 in order to bring at least one storage shelf 5 of a paternoster device 3 into a favourable position for the intended deposition or removal of specimens, with at least one storage shelf 5 being positioned in the area of the upper circulatory semicircle of this paternoster device 3. The robot 7, also controlled by the master computer 60, then deposits a specified number of particular specimens in the storage shelves 5 made available and/or removes these specimens from these storage shelves 5. While the robot 7 is operating in the transfer area 6, the paternoster devices 3 can be moved into a further operational position with storage shelves that have already been processed. Preferably, the computer 60 coordinates and optimises the paths of the robot 7 and the paths of rotation (and rotational directions if required) of the paternoster devices 3 with respect to each other in such a way that the shortest work time possible for the robot 7 is the result. Consequently, the preferred master computer 60, which can be arranged inside or outside the housing 8 of the compact storage system 1, controls the robot 7 and the paternoster devices 3 according to a temporally optimised schedule. As described, in order to position a specific storage shelf 5 at least in the vicinity of the upper inflection point 12 of the paternoster device 3, each paternoster device 3 can preferably be circulated forwards or backwards as required, depending on the current position of the specific storage shelf 5.

Preferably, the robot 7 comprises one transfer station 23. The test tubes are made available in this by means of arranging at least two racks and/or magazines one above the other and test tubes in the form of tubes 22 being pressed out of the upper container rack 21 by a tool and/or a manipulator 25 into the accommodating cavities of the lower work magazine 24, which are positioned according to the index. On the other hand, this transfer process can also be executed by means of a manipulator pressing the tubes out of the lower rack into the accommodating cavities of the upper rack, which are positioned according to the index. The positions of the container rack 21 and work magazine 24 can also be interchanged as required, with the robot working on two container racks 21 or two work magazines 24 depending on requirements.

Highly preferable in terms of the temporally optimised working mode of the robot 7, is for the robot 7 to comprise two heads 18,19, each with a gripper 20, with which it can grasp two container racks 21 with tubes 22 from a storage shelf 5 or from a transfer frame 11 essentially simultaneously and to make them available for redistributing these tubes 22 in its transfer station 23. The work time of the robot for purely removing or depositing containers 17 or container racks 21 is halved by it being equipped with two gripper heads 18,19.

As described, each paternoster device 3 is preferably constructed within a rack 27 and can be removed laterally from the housing 8 of the compact storage system 1 together with this rack 27 through an opening 28 for servicing purposes. This is particularly advantageous in the second embodiment of the compact storage system 1, because a single paternoster device 3 can be removed from the housing 8, without the other paternoster devices 3 located in individual storage chambers 13 (cf. FIG. 3) being compromised with respect to their temperature or functionality.

The paternoster device 3 to be removed can be emptied in advance using the robot 7. This is particularly recommendable when maintenance or repair works needs to be performed on the paternoster device 3 or on the relevant storage chamber 13.

However, it is also possible to slide the extracted paternoster device 3, including all of the frozen specimens stored within it, into another refrigerated device or even into another compact storage system 1. This other refrigerated device can be a stationary or a transportable refrigeration device.

To the extent that features of the disclosed variants of the paternoster devices 5 and of the embodiments of the compact storage system 1 can be combined, such combinations fall within the scope of the present invention. The same reference symbols in the figures relate to identical features, even if these were not expressly described in each case.

The problem of unambiguously identifying the specimens stored in this compact storage system 1 is preferably resolved by providing all transportable parts of the compact storage system with a means of identification. These transportable parts comprise in particular storage shelves 5, transfer frames 11, containers or vials 17, container racks 21, tubes 22 and work magazines 14. Moreover, localising a particular tube 22 is simplified by the SBS standard, which involves numbering the compartments 26 in terms of rows and columns. All common means of identification can be used as means of identification, provided they withstand the low storage temperatures. Consequently, optically readable means of identification such as (1-, 2-, or 3-dimensional) bar codes or wireless identification and means of identification that can be read without visual contact, for instance by means of radio frequency tags (“RFID tags”) come into special consideration. Other wireless systems, such as RuBee, ZIGBee, or Bluetooth are also preferred depending on suitability. Highly preferable is the identification of larger transportable parts, such as for instance the storage shelves 5, transfer frames 11, containers or vials 17 and container racks 21, by means of one-dimensional bar codes. Preferably, small transportable parts, such as tubes 22, are provided with a 2-dimensional barcode (not shown).

Preferably, the robot 7 is equipped with an identification reader, such as for instance a barcode reader, so that it can read the appropriate means of identification on the parts of the compact storage system that need to be picked up, transported, set down or have been set down (not shown). However, provision can also be made for a central apparatus of each individual paternoster device 3 and/or of the complete compact storage system 1 to take on the identification process for the individual transportable parts or at least to support the robot 7 in executing particular identification tasks. Highly preferred is for the computer 60 to monitor and store identifications so that the storage lists and transfer lists can be displayed and/or printed out. Particularly in the case of specimens being automatically loaded, preferably taking place through a lock 33, determining the identity and the allocated storage locations of the individual specimens or other transportable parts is of great importance. Thanks to such an identification system, an exact inventory can be retrieved from the computer 60 at any time.

### REFERENCE SYMBOLS

| | |
|---|---|
| 1 | Compact storage system |
| 2 | Storage area |
| 3 | Paternoster device |
| 4 | Longitudinal axis |
| 5 | Storage shelf |
| 6 | Transfer area |
| 7 | Robot |
| 8 | Housing |
| 9 | Thermal insulation |
| 10 | Refrigeration unit |
| 11 | Transfer frame |
| 12 | Inflection point |
| 13 | Storage chambers |
| 14 | Partitions |
| 15 | Loading hatch |
| 16 | Gripper frame |
| 17 | Container, vial |
| 18 | First head |
| 19 | Second head |
| 20 | Gripper |
| 21 | Container rack |
| 22 | Tubes |
| 23 | Transfer station |
| 24 | Work magazine |
| 25 | Puncher, manipulator |
| 26 | Compartment |
| 27 | Rack |
| 28 | Opening |
| 29 | Cover |
| 30 | Structural frame |
| 31 | Ends |
| 32 | Main chain drive |
| 33 | Lock |
| 34 | Sprocket wheels |
| 35 | Shaft |
| 36 | Cam disc |
| 37 | Shelf bearers |
| 38 | Upper opening |
| 39 | Lower opening |
| 40 | Partition |
| 41 | Axial offset dimension |
| 42 | Lateral offset dimension |
| 43 | Lateral chain drive |
| 44 | Dummy bearers |
| 45 | Cam rail |
| 46 | Connection |
| 47 | Elongated part |
| 48 | Transverse shanks |
| 49 | Sleeves |
| 50 | Rollers |
| 51 | Rotary flanges |
| 52 | Moulded supports |
| 53 | Guide rails |
| 54 | Drive motor |
| 55 | Rotary joint |
| 56 | Toothed drive wheel |
| 57 | Intermediate toothed wheel |
| 58 | Cam bails |
| 59 | Toothed drive wheel |
| 60 | Computer |
| 61 | Supporting chain |

What is claimed is:

1. A compact storage system (1) with one storage area (2), a housing (8) comprising thermal insulation (9) and at least one refrigeration unit (10), with which at least the storage area (2) is accomplished to be coolable to a temperature below −15° C., with the compact storage system (1) comprising storage shelves (5) arranged completely within the refrigerated storage area (2) and a transfer area (6) arranged above this storage area (2), in which an essentially horizontally displaceable robot (7) is arranged, wherein the compact storage system (1) comprises at least one essentially vertical paternoster device (3) arranged in the storage area (2), which paternoster device (3) comprises a longitudinal axis (4) and a plurality of essentially horizontally oriented storage shelves (5) circulating on an essentially oval path, with the robot (7) working in conjunction with the paternoster device (3) and being accomplished for removing or depositing a storage shelf (5) and/or objects from/onto a storage shelf (5) respectively, the robot (7) being capable of this removing or depositing, when at least one storage shelf (5) is located in the area of the upper semicircle of the path of this paternoster device (3), with these objects being selected from a group comprising the transfer frame (11), container racks (21) and containers (17).

2. The compact storage system (1) of claim 1, wherein the robot (7) is embodied for the purpose of and being capable of removing or depositing a storage shelf (5) and/or objects from/onto a storage shelf (5) respectively, when this storage shelf (5) is located at least near the upper inflection point (12).

3. The compact storage system (1) of claim 1, wherein the robot (7) is embodied for the purpose of and being capable of removing or depositing a storage shelf (5) and/or objects from/onto a storage shelf (5) respectively, when two storage shelves (5) are each positioned at a distance from the upper inflection point (12) that is essentially one quarter of the upper circulatory semi-circle.

4. The compact storage system (1) of claim 1, wherein the storage area (2) comprises at least two paternoster devices (3) arranged essentially parallel adjacent to each other, with the robot (7) accomplished such that it is displaceable perpendicular to the longitudinal axes (4) of these paternoster devices (3).

5. The compact storage system (1) of claim 1, wherein the storage area (2) comprises storage chambers (13) that are separated from each other by means of thermally insulated partitions (14), with one paternoster device (3) arranged in each storage chamber (13).

6. The compact storage system (1) of claim 5, wherein each storage chamber (13) comprises at least one sealable loading hatch (15).

7. The compact storage system (1) of claim 1, wherein the storage area (2) is accomplished to be coolable to a temperature that is −35° C. or lower and the transfer area (6) is accomplished to be coolable to a temperature below −15° C.

8. The compact storage system (1) of claim 7, wherein the storage area (2) is accomplished to be coolable to a temperature of −80° C. and the transfer area (6) is accomplished to be coolable to a temperature of −20° C.

9. The compact storage system (1) of claim 1, wherein the robot (7) comprises at least one gripper frame (16) to block a paternoster device (3) and to remove and/or deposit a transfer frame (11) from a storage shelf (5) or to remove and/or deposit a storage shelf (5) of the blocked paternoster device (3).

10. The compact storage system (1) of claim 1, wherein the robot (7) comprises one or two heads (18,19), each equipped with one gripper (20) for grasping container racks (21) with specimen containers (17,22) or for grasping specimen containers (17) arranged in container racks (21) or transfer frames (11).

11. The compact storage system (1) of claim 10, wherein the robot (7) comprises a transfer station (23) with a puncher (25) for redistributing the specimen containers (17,22) in work magazines (24), with this puncher (25) being accomplished for pressing tubes (22) out of compartments (26) of a container rack (21) into compartments (26) of a work magazine (24) arranged below or above this container rack (21).

12. The compact storage system (1) of claim 5, wherein each paternoster device (3) is constructed in a rack (27) and is embodied so that it is, together with this rack (27), removable laterally from the housing (8) of the compact storage system (1) through an opening (28), with this opening (28) being sealed by means of a cover (29) equipped with thermal insulation (9) when the paternoster device (3) has been inserted.

13. The compact storage system (1) of claim 1, wherein each paternoster device (3) at its two ends (31) comprises two main chain drives (32) that are arranged essentially vertical and are provided with roller chains that run around upper and lower sprocket wheels (34), the main chain drives (32) being mechanically connected to each other by means of at least one shaft (35), with adjacent links of the chains being connected to each other by means of link plates developed as shelf bearers (37).

14. The compact storage system (1) of claim 13, wherein each paternoster device (3) comprises one lateral chain drive (43) that is arranged essentially vertical at one of its ends (31) and is provided with roller chains that run around upper and lower sprocket wheels (34) and that are offset from the main chain drive (32) by an axial offset dimension (41) and a lateral offset dimension (42), with adjacent links of the lateral chains being connected to each other by means of link plates embodied as dummy bearers (44).

15. The compact storage system (1) in accordance with the claim 13, wherein each shelf bearer (37) is connected to a dummy bearer (44) by means of an intrinsically rigid articulated connection (46) that bridges the axial offset dimension (41) and the lateral offset dimension (42).

16. The compact storage system (1) of claim 15, wherein link pins are inserted through the shelf bearers (37) or through the dummy bearers (44) respectively.

17. The compact storage system (1) of claim 13, wherein each of these paternoster devices (3) comprises one essentially vertical cam disc (36) arranged at one of their ends (31), with a cam rail (45) and cam bails (58), with each dimensionally stable cam bail corresponding with a shelf bearer (37) carrying a storage shelf (5) and being pivotally connected to this shelf bearer (37).

18. A method for storing and making available frozen specimens in a compact storage system (1) with one storage area (2), a housing (8) comprising thermal insulation (9) and at least one refrigeration unit (10), with which at least the storage area (2) is accomplished to be coolable to a temperature below −15° C., with the compact storage system (1) comprising storage shelves (5) arranged completely within the refrigerated storage area (2) and a transfer area (6) arranged above this storage area (2), in which an essentially horizontally displaceable robot (7) is arranged, wherein the frozen specimens are stored in or are made available from at least one at least essentially vertical paternoster device (3) that is arranged in the storage area (2) of the compact storage system (1), which paternoster device (3) comprises a longitudinal axis (4) and a plurality of essentially horizontally oriented storage shelves (5) circulating on an essentially oval path, and wherein the robot (7) works in conjunction with the paternoster device (3) and removes or deposits a storage shelf (5) and/or objects from/onto a storage shelf (5) respectively, the robot (7) being capable of this removing or depositing, when at least one storage shelf (5) is located in the area of the upper semicircle of the path of this paternoster device (3), with these objects being selected from a group comprising the transfer frame (11), container racks (21) and containers (17).

19. The method of claim 18, wherein each paternoster device (3) is provided with its own drive motor (54), which allows each paternoster device (3) to be moved independently of the other paternoster devices (3).

20. The method of claim 19, wherein the drive motors (54) of all the paternoster devices (3) are controlled by a master computer (60) in order to bring at least one storage shelf (5) of a paternoster device (3) into a favourable position for the intended deposition or removal of specimens, with at least one storage shelf (5) being positioned in the area of the upper semicircle of the circulatory path of this paternoster device (3).

21. The method of claim 20, wherein the robot (7), which is also controlled by the master computer (60), deposits and/or removes a specified number of particular specimens into/from the storage shelves (5) made available.

22. The method in accordance with claim 20, wherein the master computer (60) controls the robot (7) and the paternoster devices (3) in accordance with a temporally optimised schedule.
